(19) United States
(12) Patent Application Publication
(10) Pub. No.: US 2026/0088312 A1
(43) Pub. Date: Mar. 26, 2026

(54) METHOD FOR MANUFACTURING A MEMBRANE ELECTRODE ASSEMBLY (MEA) FOR AN ELECTROCHEMICAL CELL AND APPARATUS FOR MANUFACTURING THE MEA

(71) Applicant: Carl Freudenberg KG, Weinheim (DE)

(72) Inventors: Pascal PENOTY, Kirchseeon (DE); Jacqueline KOHL, Baldham (DE)

(21) Appl. No.: 19/329,609

(22) Filed: Sep. 16, 2025

(30) Foreign Application Priority Data
Sep. 25, 2024 (DE) 10 2024 127 701.7

(51) Int. Cl. H01M 8/0245; H01M 4/86; H01M 8/023; H01M 8/0247; H01M 8/0286; H01M 8/10; H01M 8/1004

(52) U.S. Cl. CPC H01M 8/0245; H01M 4/8605; H01M 8/023; H01M 8/0247; H01M 8/0286; H01M 8/1004; H01M 2008/1095

(57) ABSTRACT

A method for manufacturing a membrane electrode assembly (MEA) for an electrochemical cell, includes providing: a layer including a gas-diffusion layer and a microporous layer, a layer as a membrane layer coated with catalysts including a proton exchange membrane on which a catalyst layer is applied on both sides, and a layer including a gas-diffusion layer and a microporous layer, each as a web-shaped material. The three layers are brought together such that a web-shaped 7-layer membrane electrode assembly is formed and laminated. A web-shaped carrier layer is provided and fed to the web-shaped 7-layer membrane electrode assembly such that the assembly rests on the web-shaped carrier layer. The web-shaped 7-layer membrane electrode assembly is fabricated by cutting out a desired contour so that individual sheet-like 7-layer membrane electrode assemblies are created.

### CROSS REFERENCE TO RELATED APPLICATIONS

This application claims benefit to German Patent Application No. DE 10 2024 127 701.7, filed on Sep. 25, 2024, which is hereby incorporated by reference herein.

### FIELD

The invention relates to a method for manufacturing a membrane electrode assembly (MEA) for an electrochemical cell as well as to an apparatus for manufacturing a membrane electrode assembly according to this method.

### BACKGROUND

Membrane electrode assemblies (MEAs), in the following referred to as MEA or MEAs, are the core component in so-called polymer electrolyte membrane (PEM) fuel cells. The electrochemical reactions of a fuel cell or electrolyzer take place in the MEA. The MEA therefore consists of various functional active materials; known for example, is a 7-layer structure of the MEA.

In the simplest case, the MEA comprises a proton exchange membrane (PEM) made of a polymeric, ion-conducting material sandwiched between two electrodes (anode and cathode), each consisting of a carbon catalyst layer, on each side of a microporous layer (MPL) and of a porous, air-permeable gas diffusion layer (GDL).

The composite of the PEM membrane and the electrodes is also referred to as CCM (catalyst coated membrane). If the electrodes are applied directly to the GDL, the composite of catalyst coated GDL is also called gas diffusion electrodes (GDEs). The GDL is usually coated with a microporous layer (MPL) on the catalyst side.

The electrodes usually comprise catalysts that are combined with the so-called ionomer. The anodic hydrogen oxidation reaction and the cathodic oxygen reduction reaction take place on the catalyst surface. These reactions generate the electricity that can later be used from the chemical energy of the fuels. The ionomer performs the electrolytic conduction function, while the catalyst carrier or the catalyst itself performs the electrical conduction.

The membrane separates the electrodes from each other. It not only prevents the flow of electrons, but also the exchange of gases between the two electrodes. In addition to its separating function, the membrane also has the function to allow the diffusion of protons (product of the anodic hydrogen oxidation reaction) from the anode to the cathode. These protons react at the cathode to form water.

The GDL and the MPL applied to it have the function of both removing and supplying the reactants of the electrochemical partial reactions (hydrogen and atmospheric oxygen) as well as the water produced during the reactions, to and from the electrodes.

In order to operate the MEA, the two electrodes must also be separated in a gas-tight manner at the interface to the periphery; this is ensured by the so-called gasket (sometimes also referred to as the inner seal). The gasket separates the media of the anode and cathode at the interface of the active materials (electrodes, membrane, GDL/MPL).

EP 3 496 194 B1 describes so-called flush-cut MEAs in which the central proton exchange membrane and the electrodes surrounding it in a sandwich configuration form a flush seal with the gas diffusion layers. When fabricating individual MEAs from a web-shaped 7-layer MEA composite material, it is important to ensure a clean separation edge; and it is important to avoid cutting individual fibers of the GDL uncleanly, as these could electrically bridge the proton exchange membrane. This would adversely affect the functionality of the MEA and thus the electrochemical cell that houses it.

### SUMMARY

In an embodiment, the present disclosure provides a method for manufacturing a membrane electrode assembly (MEA)for an electrochemical cell that includes providing: a layer including a gas-diffusion layer and a microporous layer, a layer as a membrane layer coated with catalysts including a proton exchange membrane on which a catalyst layer is applied on both sides, and a layer including a gas-diffusion layer and a microporous layer, each as a web-shaped material. The three layers are brought together such that a web-shaped 7-layer membrane electrode assembly is formed and laminated. A web-shaped carrier layer is provided and fed to the web-shaped 7-layer membrane electrode assembly such that the assembly rests on the web-shaped carrier layer. The web-shaped 7-layer membrane electrode assembly is fabricated by cutting out a desired contour so that individual sheet-like 7-layer membrane electrode assemblies are created.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an apparatus for manufacturing an MEA in accordance with an embodiment of the present disclosure; and

FIG. 2 shows the structure of a 7-layer MEA.

### DETAILED DESCRIPTION

Embodiments of the present disclosure include a method for manufacturing a membrane electrode assembly (MEA) for an electrochemical cell and an apparatus for manufacturing a membrane electrode assembly, which enable individual MEAs to be fabricated from a web-shaped 7-layer MEA composite material with a clean separation edge.

According to embodiments of the present disclosure, it has been found advantageous to laminate the MEA prior to fabrication, e.g., by punching the MEA, and to support the MEA during the fabrication process by means of a carrier layer.

The method according to an embodiment of the present disclosure is used for manufacturing a membrane electrode assembly (MEA) for an electrochemical cell, in particular a fuel cell, and comprises the following steps:
providing a layer comprising a gas-diffusion layer (GDL) and a microporous layer (MPL), a layer as a catalyst-coated membrane layer comprising a proton exchange membrane (PEM) on which a catalyst layer (CL) is applied on both sides, and a layer comprising a gas-diffusion layer (GDL) and a microporous layer (MPL) each as a web-shaped material.

Bringing together the three layers mentioned above in such a way that the layers lie on top of each other in a sandwich configuration to form a web-shaped 7-layer membrane electrode assembly (MEA) as a composite material.

Laminating the web-shaped 7-layer membrane electrode assembly, i.e., guiding the web-shaped 7-layer membrane electrode assembly through at least one pair of calenderers, wherein the 7-layer membrane electrode assembly is bonded together by the application of heat and pressure. The different layers of the 7-layer membrane electrode assembly can then be processed as a single component.

Providing a web-shaped carrier layer, which can be configured as a carrier film.

Feeding the carrier layer to the web-shaped 7-layer membrane electrode assembly in such a way that the web-shaped 7-layer membrane electrode assembly rests on the carrier layer. The carrier layer serves to reinforce and support the 7-layer membrane electrode assembly, as well as to support the cut for complete cutting through the MEA and thus a straight cut edge without fibers. Both are transported further together to a subsequent fabrication unit, e.g., a punching station.

Fabricating the 7-layer membrane electrode assembly by cutting out the desired contour such that individual sheet-like 7-layer membrane electrode assemblies are formed. During the fabrication from the web-shaped 7-layer membrane electrode assembly, individual sheet-like 7-layer membrane electrode assemblies are cut out, which can also be referred to as MEA blanks, while the remaining web material can be referred to as MEA waste. If fabrication is carried out by punching, the MEA waste is punching waste or punching residue. During fabrication, the carrier layer is not completely cut through, but at most its cross-section is weakened. By calendering the MEA prior to fabrication in combination with providing a carrier layer for the duration of the fabrication process, it is advantageously ensured that the 7-layer membrane electrode assembly is fully and cleanly cut along the intended separation contour. In addition, the 7-layer membrane electrode assembly is protected from possible contamination by the underlying material.

In an embodiment of the present disclosure, the method further includes:

Removing the waste in such a way that individual sheet-like 7-layer membrane electrode assemblies remain. In other words, the MEA waste is removed and the MEA blanks remain.

In an embodiment of the present disclosure, the method further includes:

Removing the carrier layer, in particular by delaminating the carrier layer from the fabricated MEA. The carrier layer serves to support the fabrication process and can therefore be removed again after fabrication was carried out.

The two aforementioned steps of removing the waste and removing the carrier layer can also be carried out simultaneously if necessary.

In an embodiment of the present disclosure, the formed web-shaped 7-layer membrane electrode assembly has the following structure:
gas-diffusion layer (GDL), microporous layer (MPL), catalyst layer (CL), proton exchange membrane (PEM), catalyst layer (CL), microporous layer (MPL), gas-diffusion layer (GDL).

In an embodiment of the present disclosure, the lamination is carried out with at least one pair of heated rollers. The following material pairings can be provided for the roller pairs: steel-steel, rubber-steel, rubber-rubber. In an embodiment of the present disclosure, lamination is carried out in particular under the following conditions, which have proven to be suitable and ensure particularly good treatment of the web-shaped 7-layer membrane electrode assembly: a pressure in the range of 0.5 MPa-5 MPa at a temperature in the range of 100° C.-200° C.

In an embodiment of the present disclosure, the carrier layer is a carrier film made of a plastic material.

In an embodiment of the present disclosure, the fabrication is carried out by punching, in particular by continuous rotary punching or quasi-continuous flatbed punching.

The punching pressure is such that the carrier layer is not completely cut-through. Thus, this forms a punching base for the 7-layer membrane electrode assembly, which is cut through across its entire cross-section.

Embodiments of the present disclosure include a method for manufacturing a fuel cell, wherein a membrane electrode assembly is manufactured according to the method described above and then a sealing structure, a so-called gasket, is applied to one side of the membrane electrode assembly and then a bipolar plate is applied to both sides.

Embodiments of the present disclosure include an apparatus for manufacturing a membrane electrode assembly as described above, comprising and arranged in succession in the direction of transport and material flow:
a supply unit each for supplying, in each case as a web-shaped material, a
layer comprising a gas-diffusion layer (GDL) and a microporous layer (MPL), a
layer as a catalyst-coated membrane layer and a
layer comprising a gas-diffusion layer (GDL) and a microporous layer (MPL)
a laminating unit for bringing the three layers together such as to form a web-shaped 7-layer membrane electrode assembly,
a supply unit for supplying a web-shaped carrier layer,
a feed unit for feeding the carrier layer to the web-shaped 7-layer membrane electrode assembly. The carrier layer serves to reinforce and support the 7-layer membrane electrode assembly, and both are transported further together to a subsequent punching unit and finally
a punching unit for fabricating the 7-layer membrane electrode assembly by cutting out the desired contour.

In an embodiment of the apparatus the following is also provided:
a disposal unit for winding up the 7-layer MEA waste web.

In an embodiment of the apparatus the following is also provided:
a disposal unit for delaminating and winding up the carrier layer.

### EXEMPLARY EMBODIMENT

Embodiments of the present disclosure will be explained in more detail with reference to the accompanying figures. Corresponding elements and components are identified in the figures with the same reference numerals. For the sake of clarity, the figures are not drawn to scale.

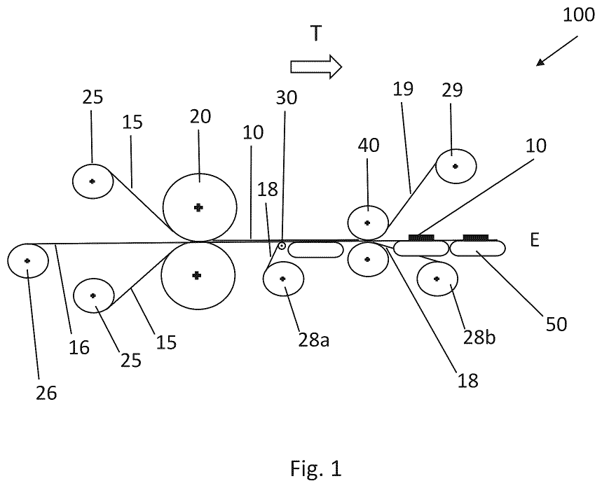

FIG. 1 shows an apparatus 100 for manufacturing a MEA, a membrane electrode assembly 10. A first layer 15 comprising a gas-diffusion layer (GDL) 14 and a microporous layer (MPL) 13, is supplied from a supply unit 25 as web-shaped material, from a further supply unit 26, a second web-shaped layer 16, which is a membrane layer 11 coated with catalysts 12, is supplied - here in the horizontal transport plane - and a third layer 15, which again comprises a gas-diffusion layer (GDL) 14 and a microporous layer (MPL) 13, is supplied from another supply unit 25, so that the second layer is located between the first and third layers. Layer 15, again comprising a gas-diffusion layer (GDL) 14 and a microporous layer (MPL) 13, is fed in, so that the second layer is located between the first and third layers and is enclosed in a sandwich-like manner. These three layers 15, 16, 15 together form the MEA 10, which are brought together in a laminating unit 20 in such a way that a web-shaped 7-layer membrane electrode assembly is formed as composite material from interconnected layers.

When guiding the web-shaped 7-layer membrane electrode assembly 10 through the laminating roller pair 20, the 7-layer membrane electrode assembly is rolled and subjected to pressure. The different layers of the 7-layer membrane electrode assembly 10 are thus laminated and bonded together particularly well before further processing, in particular before fabrication. A web-shaped carrier layer 18 is then provided by a supply unit 28a and fed to the web-shaped 7-layer membrane electrode assembly 10, so that the MEA 10 is supported on one side by the carrier layer 18. Both together are transported in the transport direction T to the next processing station, to a punching unit 40 configured as a continuously operating rotary punch. This is used to fabricate the 7-layer membrane electrode assembly 10 by cutting out the desired contour.

During fabrication from the web-shaped 7-layer membrane electrode assembly 10, individual sheet-like 7-layer membrane electrode assemblies 10 are cut out, which can also be referred to as MEA blanks, whereas the remaining web material can be referred to as MEA waste 19 or as punching waste or punching residue. During fabrication, the carrier layer 18 is not completely cut through, but at most weakened in its cross-section. This ensures that the 7-layer membrane electrode assembly 10 is completely cut through along the intended separation contour.

In the following, in the apparatus 100, a disposal unit 29 for winding up the 7-layer MEA waste web 19 and a disposal unit 28b for delaminating and winding up the carrier layer 18 are provided. The disposal of the MEA waste web 19 and the delamination of the carrier layer 18 can be—as shown here—carried out simultaneously. However, it would also be conceivable to arrange these processing stations—in the direction of transport—one after the other. The remaining individual sheet-like 7-layer membrane electrode assemblies 10 can be transported further by means of a transport unit 50 (e.g., a vacuum belt) and thus fed to a further processing, e.g. fitted with gaskets and bipolar plates and then, for example, fed to a device for stacking the MEAs 10 or, alternatively, they can also be temporarily stored.

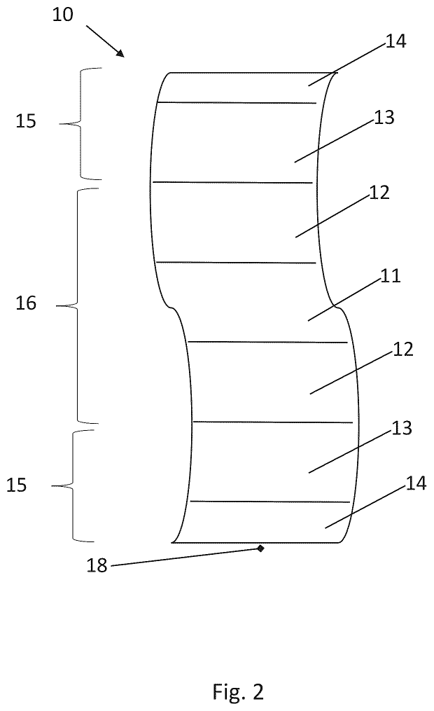

FIG. 2 shows the structure of a 7-layer membrane electrode assembly MEA 10 as can be manufactured on the apparatus 100 described above. Only a section is shown as a cross-sectional view through the MEA 10.

Arranged sequentially and stacked on top of each other are a gas-diffusion layer (GDL) 14, a microporous layer (MPL) 13, a catalyst layer (CL) 12, a proton exchange membrane (PEM) 11, a catalyst layer (CL) 12, a microporous layer (MPL) 13 and a gas-diffusion layer (GDL) 14 so that a structure symmetrical to the proton exchange membrane (PEM) 11 is formed. A gas-diffusion layer (GDL) 14 and a microporous layer (MPL) 13 together form a first layer 15, a proton exchange membrane (PEM) 11, on both sides of which a catalyst layer (CL) 12 is applied, forms a second layer 16, and a third layer (15) is formed again by a gas-diffusion layer (GDL) 14 and a microporous layer (MPL) 13. The three layers are laminated together to form a composite material as described above. The position of the carrier layer 18, which temporarily supports the MEA 10, namely during the punching process for fabricating the individual web-shaped MEAs 10, is only indicated.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 7-layer MEA
1 proton exchange membrane (PEM)
12 catalyst layer (CL)
13 microporous layer (MPL)
14 gas-diffusion layer (GDL)
15 web made of GDL and MPL
16 web made of laminated CL, PEM, and CL
18 carrier layer
19 7-layer MEA waste web
20 calendering unit with pair of calender rollers
21
25 supply unit for supplying a gas diffusion layer (GDL) and a microporous layer (MPL)
28a supply unit for supplying a carrier layer
28b disposal unit for winding up the carrier layer
29 disposal unit for winding up the 7-layer MEA waste web
40 punching unit
50 transport device
100 apparatus for manufacturing a membrane electrode unit

1. A method for manufacturing a membrane electrode assembly for an electrochemical cell, comprising the following steps:
a) providing:
1. a layer comprising a gas-diffusion layer and a microporous layer,
2. a layer as a membrane layer coated with catalysts comprising a proton exchange membrane on which a catalyst layer is applied on both sides, and
3. a layer comprising a gas-diffusion layer and a microporous layer each as a web-shaped material,
b) bringing together the three layers so as to form a web-shaped 7-layer membrane electrode assembly,
c) laminating the web-shaped 7-layer membrane electrode assembly,
d) providing a web-shaped carrier layer,
e) feeding the web-shaped carrier layer to the web-shaped 7-layer membrane electrode assembly such that the web-shaped 7-layer membrane electrode assembly rests on the web-shaped carrier layer, and
f) fabricating the web-shaped 7-layer membrane electrode assembly by cutting out a desired contour so that individual sheet-like 7-layer membrane electrode assemblies are created.

2. The method according to claim 1, further comprising:
g) removing waste so that the individual sheet-like 7-layer membrane electrode assemblies remain.

3. The method according to claim 1, further comprising:
h) removing the web-shaped carrier layer.

4. The method according to claim 1, wherein the web-shaped 7-layer membrane electrode assembly formed in step b) has the following structure:
gas-diffusion layer, microporous layer,
catalyst layer, proton exchange membrane, catalyst layer, microporous layer, gas-diffusion layer.

5. The method according to claim 1, wherein the web-shaped carrier layer is a carrier film made of a plastic material.

6. The method according to claim 1, wherein in step f) the fabricating is carried out by punching.

7. A method for manufacturing a fuel cell, wherein a membrane electrode assembly is manufactured according to claim 1, then a sealing structure is applied on one side of the membrane electrode assembly and then a bipolar plate is applied on each side.

8. An apparatus for manufacturing a membrane electrode assembly according to claim 1, comprising
a) a supply unit for supplying, in each case as a web-shaped material, a
1st layer comprising a gas-diffusion layer and a microporous layer, a
2nd layer as a membrane layer coated with catalysts, and a
3rd layer comprising a gas-diffusion layer and a microporous layer
b) a laminating unit for joining the three layers so as to form a web-shaped 7-layer membrane electrode assembly,
d) a supply unit for supplying a web-shaped carrier layer,
e) a feeding of the web-shaped carrier layer to the web-shaped 7-layer membrane electrode assembly
f) a punching unit for fabricating the 7-layer membrane electrode assembly by cutting out a desired contour.

9. The apparatus according to claim 8, further comprising:
g) a disposal unit for winding up a 7-layer MEA waste web.

10. The apparatus according to claim 9, further comprising:
h) a disposal unit for delaminating and winding up the web-shaped carrier layer.

11. The method according to claim 3, further comprising: removing the web-shaped carrier layer by delaminating the web-shaped carrier layer.

12. The method according to claim 6, wherein the punching includes continuous rotary punching or quasi-continuous flatbed punching.
